(19) United States
(12) Patent Application Publication
(10) Pub. No.: US 2005/0224168 A1
(43) Pub. Date: Oct. 13, 2005

(54) Method and device for improving adhesion of the individual layers of a composite material

(76) Inventor: Hans-Willi Mainz, HEISBERG (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/503,043

(22) PCT Filed: Jan. 29, 2003
(86) PCT No.: PCT/EP03/00872

§ 371 Date: May 31, 2005

(30) Foreign Application Priority Data
Feb. 5, 2002 (DE) 102 04 521.6

(51) Int. Cl. B32B 31/00

(52) U.S. Cl. 156/252; 156/275.1

(57) ABSTRACT

A method and an apparatus for improving the adhesion of the individual layers of a composite material made of plastic-coated cardboard, especially for the manufacture of drinks/foodstuffs composite packages, wherein the composite material has a metal layer if necessary and wherein the composite material is heated in the opening region of the later package, as well as a sheet-like composite material manufactured thereafter or a composite package manufactured therefrom, are presented and described. In order that the adhesion between the individual layers in the opening region of the later package is so much improved that during piercing of the package wall a defined destruction takes place through using the pouring element used, the composite material is compacted by a defined supply of energy and subsequent pressing together at least in the opening region of the later package. The energy supply can be provided by means of a high-frequency coil, an infrared unit or an ultrasonic welding unit.

The invention relates to a method for improving the adhesion of the individual layers of a composite material made of plastic-coated cardboard, especially for the manufacture of drinks/foodstuffs composite packages, wherein the composite material has a metal layer if necessary and wherein the composite material is reheated in the opening region of the later package.

Such multi-layer composite packages are known in a plurality of executions, for example, as flat-top composite packages. They are mainly used in the field of liquid packaging in connection with cold, cold-sterile, hot and aseptic filling.

In order to improve the handling of such composite packages and especially to make them reclosable, there is an increasing tendency to provide the composite packages with reclosable pouring elements. These pouring elements can be executed in one or several pieces and generally have an opening element as well as a lid. Today, such packages are almost exclusively available on the market with reclosable pouring elements.

EP 0 580 593 B1 for example, discloses a multi-layer composite package provided with a pouring element which serves to open the package for the first time and is equipped with a suitable closure element so that it is reclosable. In the region of the cardboard layer and the outer polyethylene layer of the composite material of the package there is provided an indentation to weaken the gable material in which an opening element joined in one piece to the pouring element is pressed into the package material to open the package.

Another known multi-layer composite package with a pouring element is described in DE 197 27 996 C2. This known pouring element has a pouring tube which at the same time serves as an opening element to pierce the package wall. Packages provided with pouring elements having screw closures are also known.

Regardless of whether the pouring elements used for this purpose are screw closures or hinged closures, the package wall must first be pierced by the opening elements of the pouring element. In order to facilitate this, the packages in question are provided with a weakening of the material in the opening region where a part of the composite layer, namely the cardboard layer and the outer polyethylene layer have been destroyed by a perforation or punching in the region of the desired opening contour.

Then, to pierce the package wall, the opening element of the pouring element merely needs to pierce through the remaining layers, usually an oxygen barrier layer (e.g. aluminium foil) and the inner (product-side) polyethylene layer. An adhesion mediator layer arranged in between is used to achieve holohedral joining of the cardboard layer to the aluminium foil. Whereas the aluminium foil tears relatively quickly on opening, the inner polyethylene layer partly stretches to a not inconsiderable extent before the desired destruction is achieved. However, since the opening elements of the pouring elements used have only a defined penetration depth, attempts have been made to take account of this problem by providing the opening elements with cutting edges or the like in order to pierce the package material better.

It has also been recognised that reheating in the opening region of the later package brings about improved adhesion between the inner polyethylene layer and the cardboard or aluminium foil layer. This reheating takes place in the prior art by applying hot air to the appropriate region. However, this hot air stream is merely blown more or less specifically into the package from above so that no regular and defined activation occurs here.

The opening region of a package is shown schematically in FIG. 7A to permit a better understanding. Shown there is a line of weakening 20 by mechanical destruction of the outer polyethylene layer and the substrate material in the region of the pouring element to be applied. To improve the adhesion, the material in this region is exposed to hot air at spots, as can be seen from FIG. 7B, where a hot air jet 21 applies hot air to the opening region around the line of weakening 20.

For various reasons, no reproducible good activation can be achieved in this fashion. Under the same conditions the activation is either too strong or to weak, too large in area, in the wrong region etc. This has the result that if there are non-activated or only insufficiently activated regions, the inner polyethylene layer becomes lifted from the cardboard or aluminium foil layer in the separating region and during the opening process can be stretched relatively severely, without definitely ripping.

The object of the invention is thus to configure and further develop the method specified initially such that the adhesion between the individual layers in the opening region of the later package is very much improved so that by using the pouring element used, a defined destruction takes place on piercing the package wall.

This object is achieved by compacting the composite material by means of a defined energy supply and subsequent pressing together at least in the region of the later pouring element. The degree of this compaction is so strong that a clean breakthrough of the package wall is ensured without any overstretching of the inner polyethylene layer during opening. It is thus almost possible to talk more of a “breaking” of the material than of a “tearing”.

The targeted and defined activation of the opening region of the later package according to the invention has the result that an intensive joint is formed between the cardboard, adhesion mediator (HV), aluminium foil and inner polyethylene layer in the opening region. At the contact points repeated melting and therefore better adhesion take place as a result of the heating. The—plasticised—inner polyethylene layer is compacted by the pressing device and brought to a lower residual thickness in the region of the opening contour. The “tear section” of the polyethylene layer is thus reduced to a minimum size according to the invention. As a result of the shortened section in which the polyethylene layer can stretch, this results in a faster (defined) tearing or this layer.

The invention has thus recognised that the composite material in the opening region of the later package is so strongly compacted (=plastically deformed) by a defined energy supply and the subsequent pressing together at least in the region of the later pouring element, that a clean breakthrough of the package wall is ensured without any overstretching of the inner polyethylene layer.

According to a further teaching of the invention, the reheating of the still sheet-like composite material takes place before application (lamination) of the inner polyethylene layer. For this purpose it is appropriate that the blanks are arranged transversely on the composite material sheet and that the heating takes place in the opening region of the later package in strips. This is especially appropriate because if the entire sheet were to be heated, the taste of the product located in the composite package would be adversely influenced by the higher tempered polyethylene.

A further teaching of the invention provides that the re-heating of the still sheet-like composite material takes place after perforation/weakening in the opening region of the later package'. In this case, it is especially advantageous if the pressing together only takes place in the region of the perforation/line-of-weakening contour in the opening region of the later package.

According to the invention, the heating may take place continuously or only in sections. For this purpose, the energy supply during heating can be cycled—matched to the sheet speed and the heating length.

In a further embodiment of the invention, however, it is also possible for the reheating to take place after manufacture of the package blank or even after formation of the package. In this last case, the heating can also take place only in the filling machine or on the mandrel wheel of the filling machine during the formation of the package or however, by means of a separate activation unit directly before the sterilisation unit of the filling machine.

According to a further teaching of the invention, the composite material is heated by a temperature ΔT from 40° C. to 140° C. which does not lead to any impairment of the taste for the product because the extent is limited to the opening region of the later package. The magnitude of the temperature actually to be applied depends on many different factors, such as, for example, the particular heating location, the type and thickness of the layer sequence of the composite, the actual temperature of the region of the composite material to be heated, the sheet speed, ambient temperature etc. For example, in the case of a composite containing aluminium foil, if the adhesion mediator layer between the substrate material consists of polyethylene (PE), during heating of the region around the later opening at least the melting point of polyethylene, which lies around 110° C., must be reached to achieve some softening of the layers. Only thus can plastic deformation be achieved during the subsequent pressing.

Depending on whether the composite material used contains a metal layer or not, alternatively a high-frequency coil (only for metal-containing composites) or an ultrasonic welding unit or infrared unit (for metal-free or metal-containing composites) are used for the heating. If none of the tools used in any case in the manufacture of the composite material or the composite packages are used for pressing together the layers, a further teaching of the invention provides that a separate treatment unit both with devices for reheating and also with devices for pressing together is provided. However, it is also possible to provide existing rotary tools such as scoring tools or rotary punches with suitable pressing devices which are matched to the contour of the opening of the later package.

If the heating and pressing together of the composite material only takes place in the filling machine, i.e. intermittently, a possible free station in the mandrel wheel can be used for this purpose or however, a separate treatment unit can be provided directly before the sterilising unit.

The invention is explained in greater detail in the following with reference to drawings showing merely preferred embodiments, wherein:

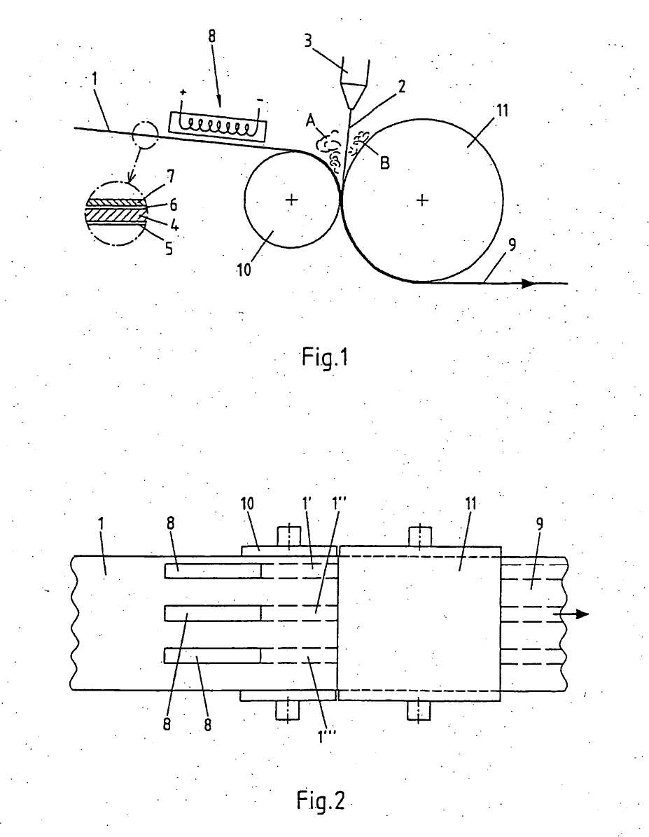

FIG. 1 is a schematic cross-sectional view of a first embodiment of the invention,

FIG. 2 is a schematic top view of the embodiment from FIG. 1,

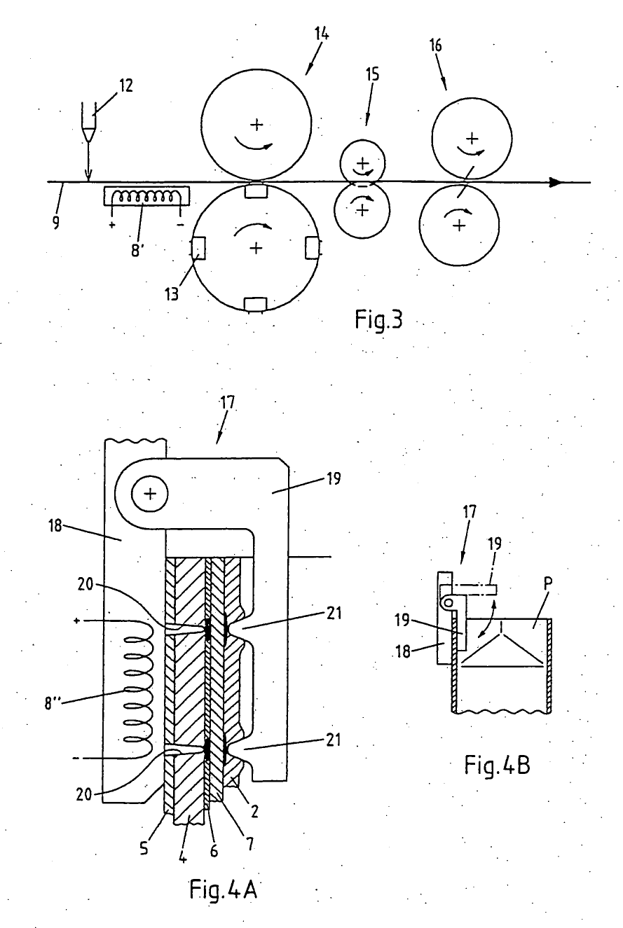

FIG. 3 is a schematic cross-sectional view of a second embodiment of the invention,

FIG. 4A is a schematic cross-sectional view of a further embodiment of the invention,

FIG. 4B is a functional view of the embodiment from FIG. 4A,

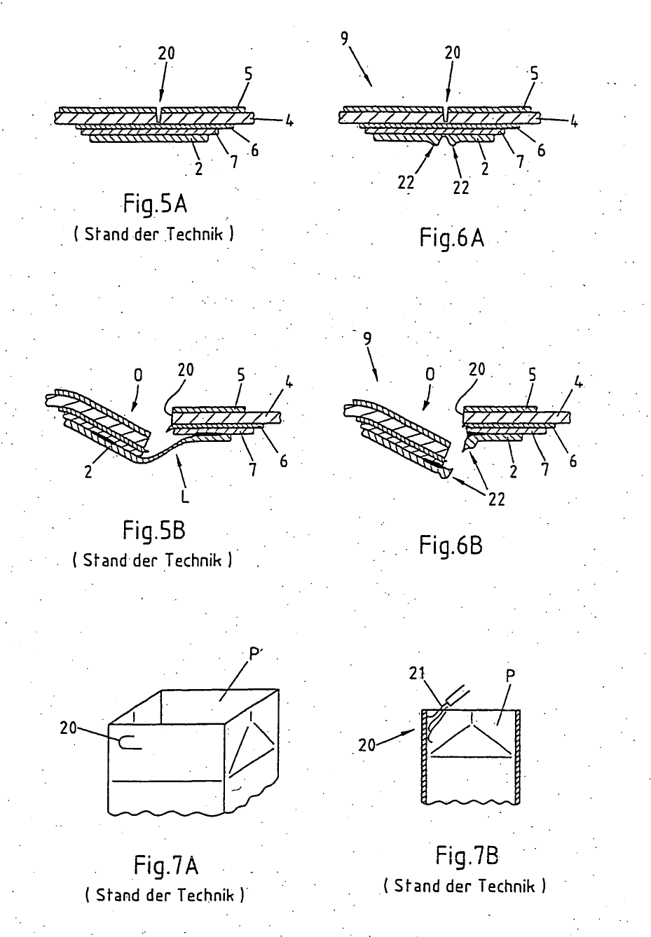

FIG. 5A is a section through the conventional composite material in the opening region of the later package,

FIG. 5B shows the conventional composite material from FIG. 5A in the opened state,

FIG. 6A is a section through the composite material according to the invention in the opening region of the later package,

FIG. 6B shows the composite material according to the invention from FIG. 6A in the opened state,

FIG. 7A is a perspective view of the position of the opening region of the later package and

FIG. 7B is a schematic cross-sectional view of the conventional melting of the region of the later opening.

In the first embodiment of the invention shown in FIG. 1, reheating of a composite material sheet 1 takes place before application of the inner polyethylene layer 2 through an extruder 3. The composite material sheet 1 in this case consists of a cardboard layer 4 as substrate material onto which an outer polyethylene layer 5 and an aluminium foil 7 combined with an adhesion mediator layer 6 have already been laminated. The composite 1 is brought to a higher temperature level by means of an additional activating unit, in the embodiment shown and insofar preferred, a high-frequency coil 8. This initially results in a softening of the adhesion mediator layer 6 between the cardboard layer 4 and the aluminium foil 7 and at the same time has the advantage that little vapour A is deposited on the heated aluminium during the subsequent lamination of the inner polyethylene layer 2. The formation of condensing vapour A, B on both sides of the still liquid polyethylene film 2 can never be completely avoided. As a result of the preheating by the high-frequency coil 8 and the lower deposition of vapour A caused thereby, better adhesion of the “finished” composite material 9 is accomplished.

FIG. 2 which gives a schematic top view of the arrangement from FIG. 1 shows the pressure roller 10 and the chill roller 11 without the extruder unit located thereabove. FIG. 2 clearly shows that not the entire composite material sheet 1 but only strip-shaped sections 1′, 1″, 1″ are heated by three high-frequency coils 8 in the embodiment shown. More appropriately, the blanks of the later packages not shown are arranged transversely on the composite material sheet 1 and the high-frequency coils 8 are located in the region of the later openings.

Another possible arrangement according to the invention is shown in FIG. 3. In this arrangement the high-frequency coils 8′ are arranged only after the perforation/weakening in the opening region of the later package below the composite material sheet 9. The line of weakening can be applied, for example, by means of a laser 12. In this alternative arrangement the reheated strip-shaped sections are compacted by means of suitable pressing elements 13 in a scoring tool 14 which is arranged before the longitudinal cutting device 15 and the transverse cutting device 16. The pressing elements 13 can have a shape matched exactly to the later opening contour.

Whereas continuous methods for reheating have been described previously, intermittent methods are also treated by the present invention. FIG. 4A and 4B show a procedure in which the reheating only takes place after the formation of the package, namely in the filling machine directly before the sterilising unit.

FIG. 4A shows pressing tongs 17 whose base body 18 contains an activating unit shown schematically as a high-frequency coil 8″. A pressing clamp 19 arranged such it can be swivelled, is matched to the later opening contour so-that-the defined reheating and subsequent compaction take place in the region of the line of weakening 20, following the contour precisely. Suitably configured cross-pieces 21 especially compact the inner polyethylene layer 2 when engaged such that any overstretching during the subsequent opening process is reliably eliminated.

The function of the pressing tongs 17 is shown schematically in FIG. 4B. These are brought from above or from the side so that they cover the opening region of a package P, wherein this zone is then activated by means of the high-frequency coil not shown here and the pressing clamp 19 is swivelled from its rest position shown by the dot-dash line into the pressing position shown.

To illustrate the invention more clearly, FIG. 5 and 6 again show a comparison of the multi-layer composite material according to the invention with the conventional material.

FIG. 5A first shows a schematic section of the conventional composite material in the opening region of the later package as can be seen at the line of weakening 20. The conventional opening process is then shown in FIG. 5B. In the region of the line of weakening 20 the aluminium layer 7 is easily destroyed when the composite material is pressed in the direction of the arrow 0 but the inner polyethylene layer 2 stretches appreciably before destruction occurs. The inadequate adhesion between the aluminium foil 7 and the inner polyethylene layer 2 results in the two layers becoming detached near the line of weakening 20 during the opening process, as shown by the arrow L. In extreme cases, this can have the result that the opening element of the pouring element not shown is not able to expose a sufficiently large pouring opening.

FIG. 6A shows the composite material 9 which has been pre-treated by the method according to the invention in the opening region of the package. It can be clearly seen that the inner polyethylene layer 2 in the region below the line of weakening 20 is so severely deformed that two thickened section 22 have formed. FIG. 6B finally shows that in the composite material according to the invention, a defined ripping of all the layers below the line of weakening 20 takes place after application of the opening force 0. Any overstretching of the inner polyethylene layer 2 is thus reliably excluded.

1. A method for improving the adhesion of the individual layers of a composite material made of plastic-coated cardboard, especially for the manufacture of drinks/foodstuffs composite packages, wherein the composite material has a metal layer if necessary and wherein the composite material is reheated in the opening region of the later package, characterised in that
the composite material is compacted by a defined energy supply and subsequent pressing together at least in the opening region of the later package.

2. The method according to claim 1, characterised in that
the reheating of the still sheet-like composite material takes place before application (lamination) of the inner polyethylene layer.

3. The method according to claim 2, characterised in that
the blanks are arranged transversely on the composite material sheet and the heating takes place in strips in the opening region of the later package.

4. The method according to claim 2, characterised in that
the blanks are arranged longitudinally on the composite material sheet and the heating takes place in sections in the opening region of the later package.

5. The method according to claim 1, characterised in that
the reheating of the still sheet-like composite material takes place after the perforation/weakening in the opening region of the later package.

6. The method according to claim 5, characterised in that
the pressing together only takes place in the region of the perforation/line-of-weakening contour in the opening region of the later package.

7. The method according to one of claims 1 to 6, characterised in that
the heating takes place continuously.

8. The method according to one of claims 1 to 6, characterised in that
the heating takes place in sections.

9. The method according to claim 1, characterised in that
the reheating takes place after manufacture of the package blank.

10. The method according to claim 1, characterised in that
the reheating takes place in the filling machine.

11. The method according to claim 10, characterised in that
the reheating takes place on the mandrel wheel of the filling machine.

12. The method according to claim 10, characterised in that
the reheating takes place before the sterilising unit of the filling machine.

13. The method according to one of claims 1 to 12, characterised in that
the composite material is heated by a temperature ΔT from 40° C. to 140° C. in the opening region of the later package.
